(19) United States
(12) Patent Application Publication
(10) Pub. No.: US 2023/0025897 A1
(43) Pub. Date: Jan. 26, 2023

(54) TONER PARTICLES

(71) Applicant: HEWLETT-PACKARD DEVELOPMENT COMPANY, L.P., Spring, TX (US)

(72) Inventors: Akinori TERADA, Yokohama, Kanagawa (JP); Keiichi ISHIKAWA, Yokohama, Kanagawa (JP); Osamu IEDA, Yokohama, Kanagawa (JP); Takahiro DANNO, Yokohama, Kanagawa (JP); Keiji KOMOTO, Yokohama, Kanagawa (JP)

(21) Appl. No.: 17/781,424

(22) PCT Filed: Oct. 21, 2020
(86) PCT No.: PCT/US2020/056657

§ 371 Date: Jun. 1, 2022

(30) Foreign Application Priority Data
Dec. 4, 2019 (JP) 2019-219541

(51) Int. Cl. G03G 9/087; G03G 9/08; G03G 9/093; G03G 9/097

(52) U.S. Cl. CPC G03G 9/08782; G03G 9/08755; G03G 9/0821; G03G 9/09328; G03G 9/0819; G03G 9/0804; G03G 9/09733; G03G 9/08797; G03G 9/08795

(57) ABSTRACT

A toner particle includes a binder resin, a colorant, a releasing agent, and a dispersant. The binder resin includes a non-crystalline polyester resin containing 1 to 15 mol % of a polyfunctional carboxylic acid unit having a pendant group with 3 to 32 carbons and a crystalline polyester resin. An endothermic amount Tg2nd-dH derived from the crystalline polyester resin is 4 to 40 J/g. The releasing agent has a melting point of 60 to 100° C. The dispersant has a melting point of 60 to 100° C. A mass ratio of the dispersant to the releasing agent is 50:50 to 95:5.

### BACKGROUND

In image forming apparatuses, electrostatic recording apparatuses and the like that carry out electrophotography, electric or magnetic latent images are rendered visible with toner. For example, in an electrophotographic method, an electrostatic image is formed on a photosensitive body and developed by use of toner, so that a toner image is formed. The toner image is subsequently transferred onto a recording medium and fixed by heating.

### BRIEF DESCRIPTION OF THE DRAWINGS

FIG. 1 is an electron microscope photograph 1 of toner particles produced under conditions of Example 1 (10,000-fold).

FIG. 2 is an electron microscope photograph 2 of toner particles produced under the conditions of Example 1 (28,000-fold).

FIG. 3 is an electron microscope photograph of toner particles produced under conditions of Comparative Example 7 (6,250-fold).

### DETAILED DESCRIPTION

In the following description, with reference to the drawings, the same reference numbers are assigned to the same components or to similar components having the same function, and overlapping description is omitted.

In a heating-fixing method of an image forming method, for fixing toner by heating, thermally-fusing and fixing toner on a recording medium consumes power. Energy may be saved by developing toner that is fixable at a lower temperature.

In order to implement low-temperature fixing, a heat characteristic of a binder resin should be considered, since the binder resin forms a large portion of toner. Combined use of a crystalline resin and a non-crystalline resin at a specific mixing ratio, and use of resins including a polar group or an aromatic group have been studied. In addition, developments have been made in adjusting physical property values such as a glass transition temperature, a weight average molecular weight and a storage elastic modulus of a resin so as to exhibit a suitable low-temperature fixing property.

In addition, a hot offset characteristic is also a heat characteristic for toner. In order to control hot offset (to further increase the temperature at which hot offset occurs), a toner should be selected to have the following two heat characteristics: being unlikely to be transferred (e.g., low transferability) to a contact surface of a fixing member such as a roller or a film by having a melt viscosity of a heated resin at a given level or higher; and being promptly released (e.g., high releasability) from the contact surface thereof. Accordingly, a releasing agent having the above characteristics should be selected or developed.

In addition, the toner is also selected to have a suitable storage stability under high temperature and high humidity. The storage stability of toner may be achieved by controlling exposure of a crystalline resin at a surface of a toner particle.

However, if a crystalline resin is present as an inner portion (core) of a toner particle and coated with a hard outer layer (shell), characteristics derived from a low melting point of the crystalline resin may be impaired, thereby possibly deteriorating the low-temperature fixing characteristic.

In order to achieve a toner particle that has improved low-temperature fixing property, hot offset property and storage stability, according to an example, a toner particle includes a binder resin, a colorant, a releasing agent, and a dispersant, such that the toner particle has a low minimum fixing temperature, a high hot offset temperature and an improved storage characteristic. In the example toner particle, a non-crystalline polyester resin containing 1 to 15 mol % of a polyfunctional carboxylic acid unit has a pendant group with 3 to 32 carbons and a crystalline polyester resin are included as the binder resin, an endothermic amount Tg2nd-dH derived from the crystalline polyester resin is 4 to 40 J/g, the releasing agent has a melting point of 60 to 100° C., the dispersant has a melting point of 60 to 100° C., and a mass ratio of the dispersant to the releasing agent is 50:50 to 95:5.

In some examples, a petroleum wax can be used as the releasing agent.

In some examples, a paraffin wax can be used as the releasing agent.

In some examples, a content ratio of the releasing agent can be 0.5 to 10 mass %.

In some examples, a carbonyl compound can be used as the dispersant.

In some examples, a linear fatty acid ester can be used as the dispersant.

In some examples, a content ratio of the dispersant can be 2 to 15 mass %.

In some examples, a resin having a weight average molecular weight of 4,000 to 80,000 can be used as the non-crystalline polyester resin.

In some examples, a resin having a weight average molecular weight of 4,000 to 30,000 can be used as the crystalline polyester resin.

In some examples, a content ratio of the non-crystalline polyester resin in the binder resin can be 40 to 90 mass %.

In some examples, a content ratio of the crystalline polyester resin in the binder resin can be 5 to 30 mass %.

In some examples, the toner particle has a temperature, at which a storage elastic modulus reaches 0.1 MPa, of 100° C. or less.

In some examples, the toner particle has an outer surface provided with a coating layer, wherein the coating layer includes at least the non-crystalline polyester resin.

In some examples, the toner particle has a volume average particle diameter of 3 to 9 μm, wherein an amount of presence of particles having a particle diameter of 3 μm or less is 3 number % or less in terms of number average particle diameter distribution.

In some examples, the toner particle can be produced by a production method including:

forming a latex of a crystalline polyester resin;

forming a latex of a non-crystalline polyester resin;

forming a liquid mixture by mixing at least the non-crystalline polyester resin latex and the crystalline polyester resin latex;

forming a primary particle aggregate by adding a coagulant to the liquid mixture to aggregate the non-crystalline polyester resin and the crystalline polyester resin;

forming coated particle aggregate by providing a surface of the primary particle aggregate with a coating layer formed of the non-crystalline polyester resin; and

fusing and coalescing the coated particle aggregate at a temperature higher than a glass transition temperature of the non-crystalline polyester resin.

The example toner particle contains a binder resin. The binder resin can be present in the toner particle at a content ratio within a range selected from, for example, 70 to 99 mass %, 75 to 95 mass %, or further 80 to 90 mass %.

The binder resin of the example toner particle may include a non-crystalline polyester resin containing a polyfunctional carboxylic acid unit having a pendant group with, for example, 3 to 32 carbons at a content ratio within a range selected from, for example, 1 to 15 mol %, 2 to 14 mol % or further 3 to 12 mol %.

The non-crystalline polyester resin can be obtained by condensation polymerization of a polyfunctional carboxylic acid and a polyol. In this case, a non-crystalline polyester resin containing a polyfunctional carboxylic acid unit can be produced by mixing, as polyfunctional carboxylic acids, a polyfunctional carboxylic acid having a pendant group with a polyfunctional carboxylic acid having no pendant group, and by causing a reaction with a polyol. The content ratio of the polyfunctional carboxylic acid unit can be adjusted by adjusting amounts of such carboxylic acids to be used. In addition, a non-crystalline polyester having a pendant group is obtained in advance from a polyfunctional carboxylic acid having a pendant group and a polyol, and separately, a non-crystalline polyester having no pendant group is obtained in advance from a polyfunctional carboxylic acid having no pendant group and a polyol; and then, these can be mixed.

For example, a non-crystalline polyester resin containing a polyfunctional carboxylic acid unit having a pendant group with 3 to 32 carbons can be obtained by using a succinic acid derivative represented by the following formula (1) as a polyfunctional carboxylic acid having a pendant group,

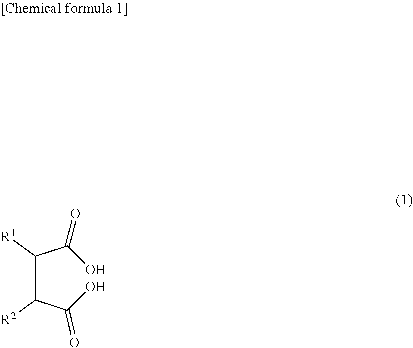

(in the formula, R¹ represents a hydrogen atom, a linear or branched alkyl group or alkenyl group with 3 to 32 carbons, or a phenyl group; and R² represents a linear or branched alkyl group or alkenyl group with 3 to 32 carbons, or a phenyl group.), or a succinic acid derivative anhydride of the formula (1) represented by the formula (2),

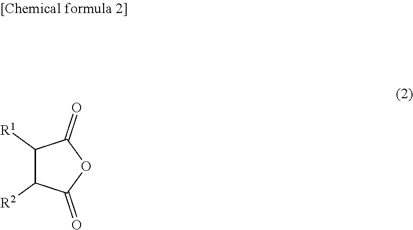

(wherein, R¹ and R² denotes the same as in the above formula (1)); and a polyfunctional carboxylic acid having no pendant group except the above, and causing these to react with a polyol.

For R¹ of the succinic acid derivative and the succinic acid derivative anhydride represented by the formulas (1) and (2), a compound of a hydrogen atom can be used. In addition, for R² that can be a pendant group, a compound with 3 to 32 carbons, 3 to 24 carbons or further 18 to 24 carbons can be used.

As the succinic acid derivative and the succinic acid derivative anhydride represented by the formulas (1) and (2), may include, for example, butyl succinate, octyl succinate, decyl succinate, dodecyl succinate, tetradecyl succinate, hexadecyl succinate, octadecyl succinate, isooctadecyl succinate (branched isomer mixture), phenyl succinate, 2-propene-1-yl succinate, 2-methyl-2-propene-1-yl succinate, 2-butene-1-yl succinate, 2-hexene-1-yl succinate, 2-octene-1-yl succinate, 2-nonene-1-yl succinate, 2-tetradecene-1-yl succinate, 2-octadecene-1-yl succinate, isooctadecenyl succinate (branched isomer mixture), 2,7-octadiene-1-yl succinate, and anhydrides thereof. In some examples, two or more compounds selected from the above compounds may be used.

Suitable forms of the succinic acid derivative (1) include, other than the succinic acid derivative anhydride (2), an ester (alkyl with 1 to 8 carbons); a diimide obtained by reaction with 4,4-diaminophenylmethane, etc.; and an isocyanate ring-containing polyimide obtained by reaction with a trimerizing reactant, etc. of tris-(β-carboxyethyl)isocyanurate, isocyanurate ring-containing polyimide, tolylene diisocyanate, xylylene diisocyanate or isophorone diisocyanate.

Examples of the polyfunctional carboxylic acid having no pendant group include polyfunctional aromatic carboxylic acids and polyfunctional aliphatic carboxylic acids with 2 to 50 carbons. Examples of the polyfunctional aromatic carboxylic acids include: difunctional aromatic carboxylic acids such as phthalic acid, isophthalic acid, terephthalic acid, tert-butylisophthalic acid, naphthalene-2,6-dicarboxylic acid, and 4,4′-biphenyl dicarboxylic acid; trifunctional aromatic carboxylic acids such as trimesic acid, trimellitic acid, and hemimellitic acid; tetrafunctional aromatic carboxylic acids such as pyromellitic acid, mellophanic acid, prehnitic acid, naphthalene-1,4,5,8-tetracarboxylic acid, naphthalene-2,3,6,7-tetracarboxylic acid, biphenyl-3,3′,4,4′-tetracarboxylic acid, perylene-3,4,9,10-tetracarboxylic acid; pentafunctional aromatic carboxylic acids such as benzene-pentacarboxylic acid; and hexafunctional aromatic carboxylic acids such as mellitic acid.

Examples of the polyfunctional aliphatic carboxylic acid having no pendant group include: difunctional aliphatic carboxylic acids such as oxalic acid, malonic acid, maleic acid, fumaric acid, citraconic acid, itaconic acid, glutaconic acid, succinic acid, glutaric acid, adipic acid, sebacic acid, azelaic acid, isooctenyl succinate, decyl succinate, dodecyl succinate, dodecenyl succinate, pentadecenyl succinate, octadenyl succinate, cyclohexane-1,4-dicarboxylic acid, dodecanedicarboxylic acid, octadecanedicarboxylic acid, and dimer acid; trifunctional aliphatic carboxylic acids such as propane-1,2,3-tricarboxylic acid, aconitic acid, butane-1,2,4-tricarboxylic acid, hexane-1,3,6-tricarboxylic acid, cyclohexane-1,3,5-tricarboxylic acid, and adamantane-1,3,5-tricarboxylic acid; tetrafunctional aliphatic carboxylic acids such as ethylenetetracarboxylic acid, butane-1,2,3,4-tetracarboxylic acid, butane-1,1,3,4-tetracarboxylic acid, cyclobutane-1,2,3,4-tetracarboxylic acid, cyclopentane-1,2,3,4-tetracarboxylic acid, octahydropentalene-1,3,4,6-tetracarboxylic acid, cyclohexane-1,2,4,5-tetracarboxylic acid, and bicyclo[2.2.2]octa-7-en-2,3,5,6-tetracarboxylic acid; and hexafunctional aliphatic carboxylic acids such as cyclohexane-1,2,3,4,5,6-hexacarboxylic acid. In some examples, two or more selected from these can be used.

Such polyfunctional carboxylic acids can be used in the form of: an anhydride; an ester (alkyl with 1 to 8 carbons); a diimide obtained by reaction with 4,4-diaminophenylmethane, etc.; and an isocyanate ring-containing polyimide obtained by reaction with a trimerizing reactant, etc. of tris-(R-carboxyethyl)isocyanurate, isocyanurate ring-containing polyimide, tolylene diisocyanate, xylylene diisocyanate or isophorone diisocyanate.

Example of the polyfunctional aromatic carboxylic acid having no pendant group include isophthalic acid, terephthalic acid, trimellitic acid and pyromellitic acid since they provide a non-crystalline polyester resin with a good fixing property. Examples of the polyfunctional aliphatic carboxylic acid having no pendant group include sebacic acid, azelaic acid and dodecanoic diacid. In some examples, two or more selected from such polyfunctional carboxylic acids may be used.

To the above polyfunctional carboxylic acid, a hydroxycarboxylic acid component such as p-oxy benzoic acid, vanillic acid, dimethylol propionic acid, malic acid, tartaric acid, and 5-hydroxyisophthalic acid may be added; and a monovalent carboxylic acid or a monovalent alcohol may be contained in order to improve molecular weight adjustment of the resin or the offset resistant property.

Examples of polyols usable for the production of the non-crystalline polyester resin include bisphenol A represented by the formula (3) below, and ethylene oxide and/or propylene oxide adducts thereof; or linear or branched polyols with 2 to 36 carbons.

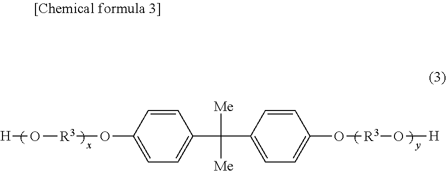

wherein R³s are the same or different and represent an ethylene group or a propylene group, x represents an integer of 0 to 10, y represents an integer of 0 to 10, and an average of the sum of x and y represents 1 to 10.
Examples of the linear or branched polyols with 2 to 36 carbons include: aromatic diols such as hydrogenated bisphenol A, bis(2-hydroxyethyl)terephthalate, and xylene glycol; aliphatic diols such as ethylene glycol, diethylene glycol, triethylene glycol, tetraethylene glycol, propylene glycol, dipropylene glycol, isopentyl glycol, 1,2-propane diol, 1,3-propane diol, 1,3-butane diol, 1,4-butane diol, 1,5-pentane diol, 1,6-hexane diol, 1,7-heptane diol, 1,8-octane diol, 1,9-nonane diol, 1,10-decane diol, 1,11-undecane diol, 1,12-dodecane diol, 1,13-tridecane diol, 1,14-tetradecane diol, 1,18-octadecane diol, 1,20-eicosane diol, 1,4-butene diol, 2,2-dimethyl-1,3-propane diol, 1,4-cyclohexane dimethanol, and 2,2,4-trimethyl-1,3-pentane diol; aliphatic triols such as glycerin, trimethylolethane and trimethylolpropane; and aliphatic tetraols such as pentaerythritol. Additional examples include saccharides such as sorbitol and sucrose. Still additional examples of the polyol include polyethylene terephthalate having hydroxyl groups at both terminals.

The polyol may include two or more selected from the above polyols. The polyol may include two or more selected from bisphenol A and ethylene oxide and/or propylene oxide adducts thereof, in order to provide a polyester resin with an improved fixing property.

From the viewpoint of dispersion of a crystalline polyester resin, the non-crystalline polyester resin may have, according to examples, a value of weight average molecular weight within a range selected from 4,000 to 80,000, 5,000 to 70,000, or further 6,000 to 60,000.

The weight average molecular weight may be determined by molecular weight measurement by way of, for example, a gel permeation chromatography (GPC) method of tetrahydrofuran (THF) soluble matter. The weight average molecular weight may be determined, for example, by the following example method. Waters e2695 (manufactured by Nihon Waters K.K.) is used as a measurement apparatus, and two consecutive Inertsil CN-3 (25 cm) (manufactured by GL Sciences Inc.) columns are used. 10 mg of non-crystalline polyester resin is input into 10 mL of THF (containing a stabilizer, manufactured by Wako Pure Chemical Industries, Ltd.) and stirred for 1 hour, and subsequently, the mixture is filtrated (or filtered) by a 0.2 μm filter and a resulting filtrate is used as a sample. 20 μL of the THF sample solution is injected into the measurement apparatus and measured under conditions of a temperature of 40° C. and a flow rate of 1.0 mL/min.

According to examples, a content ratio of the non-crystalline polyester resin in the binder resin may be a value within a range selected from, for example, 40 to 90 mass %, 50 to 85 mass % or 60 to 80 mass %.

In order to improve the low temperature fixing property, the non-crystalline polyester resin may contain a polyfunctional carboxylic acid unit having a pendant group may have a melt viscosity at 120° C. of, for example, 200 to 20,000 Pa·s, 400 to 19,500 Pa·s, or further 900 to 19,000 Pa·s. The melt viscosity mentioned herein may be measured by the following example method. A flow tester (“CFT-500D” manufactured by Shimadzu Corporation) is used; 1 g of a sample is molded under 20 MPa into a pellet and a 10 kg load is applied to the sample by a plunger at a constant temperature of 120° C.; and the sample is extruded from a nozzle having a diameter of 1 mm and a length of 1 mm. The viscosity is calculated by an amount of falling (or drop) of the plunger of the flow tester relative to the time period.

As described above, the binder resin contains a crystalline polyester resin. The crystalline polyester resin has a melting point and sharply reduces its viscosity at a temperature not less than the melting point. Accordingly, the binder resin may include a crystalline polyester resin having a low melting point to a decrease of the viscosity of the entire toner.

Examples of the polyfunctional carboxylic acid for the production of the crystalline polyester resin include polyfunctional aromatic carboxylic acids and polyfunctional aliphatic carboxylic acids with 2 to 50 carbons. Examples of the polyfunctional aromatic carboxylic acids include: difunctional aromatic carboxylic acids such as phthalic acid, isophthalic acid, terephthalic acid, tert-butylisophthalic acid, naphthalene-2,6-dicarboxylic acid, and 4,4′-biphenyl dicarboxylic acid; trifunctional aromatic carboxylic acids such as trimesic acid, trimellitic acid, and hemimellitic acid; tetrafunctional aromatic carboxylic acids such as pyromellitic acid, mellophanic acid, prehnitic acid, naphthalene-1,4,5,8-tetracarboxylic acid, naphthalene-2,3,6,7-tetracarboxylic acid, biphenyl-3,3′,4,4′-tetracarboxylic acid, perylene-3,4,9,10-tetracarboxylic acid; pentafunctional aromatic carboxylic acids such as benzene-pentacarboxylic acid; and hexafunctional aromatic carboxylic acids such as mellitic acid.

In addition, examples of suitable polyfunctional aliphatic carboxylic acids include difunctional aliphatic carboxylic acids such as oxalic acid, malonic acid, maleic acid, fumaric acid, citraconic acid, itaconic acid, glutaconic acid, succinic acid, glutaric acid, adipic acid, sebacic acid, azelaic acid, isooctenyl succinate, decyl succinate, dodecyl succinate, dodecenyl succinate, pentadecenyl succinate, octadenyl succinate, cyclohexane-1,4-dicarboxylic acid, dodecanedicarboxylic acid, octadecanedicarboxylic acid, and dimer acid; trifunctional aliphatic carboxylic acids such as propane-1,2,3-tricarboxylic acid, aconitic acid, butane-1,2,4-tricarboxylic acid, hexane-1,3,6-tricarboxylic acid, cyclohexane-1,3,5-tricarboxylic acid, and adamantane-1,3,5-tricarboxylic acid; tetrafunctional aliphatic carboxylic acids such as ethylenetetracarboxylic acid, butane-1,2,3,4-tetracarboxylic acid, butane-1,1,3,4-tetracarboxylic acid, cyclobutane-1,2,3,4-tetracarboxylic acid, cyclopentane-1,2,3,4-tetracarboxylic acid, octahydropentalene-1,3,4,6-tetracarboxylic acid, cyclohexane-1,2,4,5-tetracarboxylic acid, and bicyclo[2.2.2]octa-7-en-2,3,5,6-tetracarboxylic acid; and hexafunctional aliphatic carboxylic acids such as cyclohexane-1,2,3,4,5,6-hexacarboxylic acid. In some examples, two or more selected from these can be used.

Such polyfunctional carboxylic acids can be used in the form of: an anhydride; an ester (alkyl with 1 to 8 carbons); a diimide obtained by reaction with 4,4-diaminophenylmethane, etc.; and an isocyanate ring-containing polyimide obtained by reaction with a trimerizing reactant, etc. of tris-(R-carboxyethyl)isocyanurate, isocyanurate ring-containing polyimide, tolylene diisocyanate, xylylene diisocyanate or isophorone diisocyanate.

Among such polyfunctional carboxylic acids, an alkane dicarboxylic acid and an alkene dicarboxylic acid may provide improved or suitable crystallinity, low-temperature fixing property and heat-resistant storage stability. Examples thereof include adipic acid, sebacic acid, azelaic acid, dodecanedicarboxylic acid, octadecanedicarboxylic acid, maleic acid and fumaric acid. Such polyfunctional carboxylic acid component may be used alone or in combination of two or more kinds thereof.

A hydroxycarboxylic acid component such as p-oxy benzoic acid, vanillic acid, dimethylol propionic acid, malic acid, tartaric acid, and 5-hydroxyisophthalic acid may be added to the above-described polyfunctional carboxylic acid. The above-described polyfunctional carboxylic acid may contain a monovalent carboxylic acid or a monovalent alcohol in order to improve molecular weight adjustment of the resin or the anti-offset property improvement of the toner.

Examples of a polyol for the production of the crystalline polyester include linear polyols having an improved crystallinity. Examples thereof include ethylene glycol, 1,3-propane diol, 1,4-butane diol, 1,5-pentane diol, 1,6-hexane diol, 1,7-heptane diol, 1,8-octane diol, 1,9-nonane diol, 1,10-decane diol, 1,11-undecane diol, 1,12-dodecane diol, 1,13-tridecane diol, 1,14-tetradecane diol, 1,18-octadecane diol, and 1,20-eicosane diol; and among these, ethylene glycol, 1,3-propane diol, 1,4-butane diol, 1,6-hexane diol, 1,9-nonane diol, 1,10-decane diol, and 1,12-dodecane diol may be used in some examples. Such polyol may be used alone or in a combination of two or more kinds thereof.

In order to improve the crystal amount, the crystalline polyester resin may have a value of weight average molecular weight within a range selected from, for example, 4,000 to 30,000, 5,000 to 25,000, or further 5,500 to 20,000.

The weight average molecular weight of the crystalline polyester resin can be determined, for example, by as similar method as the weight average molecular weight of the non-crystalline polyester resin.

According to examples, the melting point of the crystalline polyester may be a temperature within a range of 50° C. to 120° C. In some example, the melting point may be a temperatures within a range of 55° C. to 100° C. to reduce the viscosity of the toner and improve heat-resistant storage stability of the toner.

According to examples, a ratio of the crystalline polyester resin in the binder resin may be within a range of 5 to 43 mass %, 7.5 to 33 mass % or 10 to 28 mass %.

The non-crystalline and crystalline polyester resins can be produced by a condensation reaction of a polyfunctional carboxylic acid and a polyol described above. The production can be made by, for example, charging a polyfunctional carboxylic acid and a polyol, and in some examples, a catalyst, into a reaction vessel provided with a thermometer, a stirrer and a flow-down type condenser and mixing them together; heating under the presence of an inert gas (e.g., nitrogen gas, etc.) at 150° C. to 250° C.; continuously removing low molecular compounds produced as by-products from a reaction system; stopping the reaction at a timing when a predetermined acid value is satisfied and cooling; and obtaining a product.

Examples of the catalyst include metal-containing compounds such as antimony-based compounds, tin-based compounds, germanium-based compounds, titanium-based compounds, zinc-based compounds, aluminum-based compounds and rare earth metal-based compounds. For example, organic metals such as dibutyltin, dilaurate, and dibutyltin oxide, or esterification catalysts such as metal alkoxides including tetrabutyl titanate can be used. Acids such as phosphoric acid and sulfonic acid; or organic bases such as amine and amide may also be used as the esterification catalyst.

According to examples, in order to reduce the impact on the environment and/or improve safety, the tin-based compounds may include tin (II) compounds having no Sn—C bond which may include tin (II) compounds having a Sn—O bond and tin (II) compounds having Sn-halogen bond. In some examples, tin (II) compounds having a Sn—O bond may be used to further reduce impact on the environment and improve safety. In addition, two or more esterification catalysts may be used as a mixture. The usage amount of an esterification catalyst may be referred to as a catalytic amount.

According to examples, a polyfunctional carboxylic acid and a polyol may have any suitable feeding ratio for the production of the polyester resin. In addition, a resulting polyester resin obtained may be caused to react with a polyfunctional carboxylic acid and/or a polyol. The above-described examples may be used as the polyfunctional carboxylic acid and/or polyol as the case may be, and the reaction can be caused under similar conditions to the above-described synthesis conditions.

The above polyester resin may be a polyester resin that has been modified to such a degree that does not substantially damage or modify its characteristics. Examples of such a modified polyester resin include: polyesters grafted or blocked by phenol, urethane, epoxy or the like; or composite resins having two or more kinds of resin units that include a polyester unit.

According to examples, the binder resin may contain, in addition to a polyester resin, a styrene-(meth)acrylic copolymer, an epoxy resin, and a styrene-butadiene copolymer. Among these, a styrene-acrylic copolymer is suitable in the case that coloring particles are produced directly by a chemical method such as an emulsification aggregation method or a suspension polymerization method.

Examples of monomers for production of a styrene-acrylic copolymer include: styrene; styrene monomers such as o-(m-, p-)methylstyrene and m-(p-)ethylstyrene; (meth)acrylate monomers such as methyl (meth)acrylate, ethyl (meth)acrylate, propyl (meth)acrylate, butyl (meth)acrylate, octyl (meth)acrylate, dodecyl (meth)acrylate, stearyl (meth)acrylate, behenyl (meth)acrylate, 2-ethylhexyl (meth)acrylate, dimethylaminoethyl (meth)acrylate and diethylaminoethyl (meth)acrylate; and ene monomers such as butadiene, isoprene, cyclohexene, (meth)acrylonitrile and acrylic acid amide.

In addition, a crosslinking agent may be used for the production of the binder resin. Among crosslinking agents used for the production of the binder resin, examples of bifunctional crosslinking agents include divinylbenzene, bis(4-acryloxy polyethoxy phenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400 and #600, dipropylene glycol diacrylate, polypropylene glycol diacrylate, polyester-type diacrylate, and those having dimethacrylate substituted for the above diacrylate.

Examples of trifunctional or higher functional crosslinking agents include pentaerythritol acrylate, trimethylolethane acrylate, trimethylolpropane acrylate, tetramethylolmethane tetraacrylate, oligoester acrylate and methacrylate thereof, 2,2-bis(4-methacryloxy polyethoxy phenyl)propane, diallyl phthalate, triallyl cyanurate, triallyl isocyanurate and triallyl trimellitate.

Such crosslinking agents can be used at a content ratio within a range of, for example, 0.01 to 10 mass % or 0.1 to 5 mass % relative to the polymerizable monomers forming the binder resin.

The differential thermal characteristic of examples of the toner particle can be measured by the following example method. A modulated differential scanning calorimeter Q2000 (manufactured by TA Instruments) is used. As a first temperature increasing process, the temperature is increased from room temperature to 140° C. at a rate of 3° C. per minute with a modulating amplitude of 0.1° C. and a modulating period of 10 seconds; and subsequently, the temperature is decreased to 0° C. at a rate of 20° C. per minute. After the temperature is kept at 0° C. for 5 minutes, the temperature is again increased as a second temperature increasing process from 0° C. to 140° C. at a rate of 3° C. per minute with a modulating amplitude of 0.1° C. and a modulating period of 10 seconds, and a dH is determined from a differential scanning calorimetry curve.

Regarding the differential thermal characteristic of the toner particle according to examples, a Tg2nd-dH representing an endothermic amount of the second temperature increasing process may be a value within a range of 4 to 40 J/g, 5 to 40 J/g, or 5 J/g more, for example, to improve the crystal amount of the crystalline polyester resin.

Example binder resins having a Tg2nd-dH in the above-described range can prevent or inhibit the glass transition temperature of the toner particle from being decreased while reducing the fixing temperature, thereby improving the storage stability of the toner particle.

According to examples, the toner particle may contain a releasing agent having a melting point at a temperature within a range of 60° C. to 100° C., to prevent or inhibit an offset phenomenon or the like at the time of contact-fixing, for example.

Examples of such releasing agents include low molecular weight polyethylenes, low molecular weight polypropylenes, and waxes such as: plant-based waxes such as carnauba wax, cotton wax, Japan wax and rice wax; animal-based waxes such as beeswax and lanolin; mineral-based waxes such as ozokerite and ceresin; and petroleum waxes such as paraffin, microcrystalline and petrolatum. In addition to such natural waxes, examples include: synthesized hydrocarbon waxes such as Fischer-Tropsch wax and polyethylene wax; and synthetic waxes such as ether waxes. Examples of suitable low molecular weight crystalline polymer resins include polyacrylate homopolymers or copolymers such as polystearyl methacrylate and polylauryl methacrylate. Example releasing agents may include petroleum waxes to improve releaseability.

According to examples, the petroleum wax may include a paraffin wax having a linear hydrocarbon as a main component. Examples of such paraffin wax include HNP-3, 5, 9, 10, 11, 12 and 51 manufactured by Nippon Seiro Co., Ltd.; C80, C80-G, C80N8, C80M, H1, H1N6, H1N8, H1N4, H1N4-G, Spray 30, Spray 30-G, and Spray 30G-EF manufactured by Sasol Limited; and Trasol PF60 manufactured by Chukyo Yushi Co., Ltd. In addition, a microcrystalline wax containing a lot of branched hydrocarbons or saturated cyclic hydrocarbons can be used, such as, for example, Hi-Mic-2095, 1090, 1080, 1070, 2065, 1045 and 2045 manufactured by Nippon Seiro Co., Ltd.; and 5803, 6403 and KTM23 manufactured by Sasol Limited.

Among such petroleum waxes, a paraffin wax may be selected for production of improved toner particles.

The content ratio of the releasing agent in the toner can be a value within a range selected from, for example, 0.5 to 10 mass %, 0.75 to 9.5 mass %, or 1.0 to 9.0 mass %.

Examples of the toner particle include a dispersant having a melting point within a range of 60° C. to 100° C. for the production of improved toner particles.

According to some examples, the dispersant may be a carbonyl compound. Examples of the carbonyl compound include linear fatty acid esters, linear fatty acid ketones and linear acid amides. Among such carbonyl compounds, linear acid esters may be selected for the production of improved toner particles.

An example of the linear fatty acid ester includes a monocarboxylic acid ester represented by the formula: R⁴COOR⁵ (4), wherein R⁴ denotes a linear alkyl group with 18 to 25 carbons, and R⁵ denotes a linear alkyl group with 18 to 30 carbons.

According to examples, the monocarboxylic acid ester of the formula (4) may be commercially available, or the ester can also be synthesized by esterification using R⁴COOH, or an acid anhydride or acid halide of R⁴COOH; and R⁵OH. In some examples, the ester can also be synthesized: through Baeyer-Villiger oxidation by peracid of R⁴—(C═O)—R⁵; through alkylation by diazoalkyl; through a nucleophilic substitution reaction on an alkyl halide by R⁴COO—; through an addition reaction by alkene or alkyne, and R⁴COOH; or the like.

According to examples, an example of the linear fatty acid ester includes a dicarboxylic acid diester represented by the formula: R⁷O—(C═O)—R⁶—(C═O)—OR⁷ (5), wherein R^{e} denotes a linear alkylene group with 14 to 30 carbons and R⁷ denotes a linear alkyl group with 1 to 25 carbons.

The dicarboxylic acid diester of the formula (5) may be commercially available, or the ester can also be synthesized through esterification by use of HOOC—R⁶—COOH, or an acid anhydride or acid halide of HOOC—R⁶—COOH, and R⁷OH. In some examples, the ester can also be synthesized: through Baeyer-Villiger oxidation by peracid of R⁷—(C═O)—R⁵—(C═O)—R⁷; through alkylation by diazoalkyl; through a nucleophilic substitution reaction on an alkyl halide by —OOC—R⁶—COO—; through an addition reaction by alkene or alkyne, and HOOC—R⁶—COOH; or the like.

An example of the linear fatty acid ketone includes a symmetrical ketone represented by the formula: R⁸—(C═O)—R^{e}(6), wherein R⁸ denotes a linear alkyl group with 10 to 20 carbons.

The symmetrical ketone of the formula (6) may be commercially available, or the ketone can also be synthesized through a reaction of R⁸—(CO)—Cl or R⁸—CN, and R⁸MgBr; by catalytic dehydrogenation of R⁸—CH(OH)—R⁸; or the like.

An example of the linear fatty acid amide, includes an amide represented by the formula: R⁹—(C═O)—NH₂ (7), wherein R⁹ denotes a linear alkyl group with 6 to 15 carbons or a linear monoalkenyl group with 15 to 25 carbons.

The amide of the formula (7) may be commercially available, or the amide can also be synthesized through a reaction between an acid anhydride, acid halide, acid azide, p-nitrophenyl ester or the like of R⁹COOH, and ammonia.

An example of the linear fatty acid amide includes a N-substituted amide represented by the formula: R¹⁰—(C═O)—NH—R¹¹ (8), wherein R¹⁰ denotes a linear alkyl group with 10 to 20 carbons or a linear monoalkenyl group with 15 to 25 carbons, and R¹¹ denotes a linear alkyl group with 10 to 20 carbons or a linear monoalkenyl group with 15 to 25 carbons.

The N-substituted amide of the formula (8) may be commercially available, or the amide can also be synthesized through a reaction between an acid anhydride, acid halide, acid azide, p-nitrophenyl ester or the like of R¹⁰COOH, and NH₂-R¹¹. In some examples, the amide can also be synthesized through a reaction between R¹⁰—CN and R¹¹—OH, through a reaction between R¹⁰—(C═O)—NH₂ and R¹¹—NH³⁺ or a reaction between R¹⁰—(C═O)—R¹¹ and NH₃, through Beckmann rearrangement of R¹⁰—(C═N(OH))—R¹¹, or the like.

An example of the linear fatty acid amide includes a N-hydroxymethyl amide represented by the formula: R¹²—(C═O)—NH—CH₂OH (9), wherein R¹² denotes a linear alkyl group with 6 to 15 carbons.

The N-hydroxymethyl amide of the formula (9) may be commercially available, or the amide can be synthesized through a reaction between R¹²-(C═O)—NH₂ and formaldehyde. In some examples, the amide can also be synthesized: through a reaction between an acid anhydride, acid halide, acid azide, p-nitrophenyl ester or the like of R⁹COOH, and NH₂—CH₂OH; or the like.

An example of the linear fatty acid amide includes a hydroxy fatty acid amide represented by the formula: HO—R¹³—(C═O)—NH₂ (10), wherein R¹³ denotes a linear alkylene group with 6 to 12 carbons.

According to examples, the hydroxy fatty acid amide of the formula (10) may be commercially available, or the amide can also be synthesized through: a reaction between an acid anhydride, acid halide, acid azide, p-nitrophenyl ester or the like of HO—R¹³COOH, and ammonia; or the like.

A content ratio of the dispersant may be within a range of, for example, 2 to 15 mass %, 2.5 to 12 mass % or further 3.0 to 10 mass %.

The mass ratio between the dispersant and the releasing agent can be a value within a range selected from, for example, 50:50 to 95:5, 55:45 to 90:10 or further 60:40 to 85:15.

The temperature at which a storage elastic modulus reaches 0.1 MPa may be 100° C. or less. A positive correlation between the storage elastic modulus and the minimum fixing temperature may serve as an index for the fixing characteristic of toner. For example, when the temperature at which the storage elastic modulus reaches 0.1 MPa is lower, the minimum fixing temperature also tends to be low.

Examples of the toner particle contains a colorant. Examples of the colorant includes dyes, pigments and the like used as a colorant for toner.

Examples thereof include carbon black, cyan, Phthalocyanine Blue, Permanent Brown FG, Brilliant Fast Scarlet, Pigment Green B, Rhodamine-B Base, Solvent Red 49, Solvent Red 146, Solvent Blue 35, quinacridone, carmine 6B, isoindoline, disazoyellow, Pigment Red, Pigment Yellow, Pigment Blue, lamp black, rose bengal, nigrosine dyes, metal complex dyes, derivatives of metal complex dyes and mixtures thereof. Additional examples thereof include various metal oxides such as silica, aluminum oxide, magnate or various ferrites, cupric oxide, nickel oxide, zinc oxide, zirconium oxide, titanium oxide and magnesium oxide; and suitable mixtures thereof. The content ratio of such colorants in the toner depends on the toner particle size or the amount of toner to be developed, but the colorants can be used at an amount within a range selected from 0.2 to 30 mass %, 1 to 20 mass %, or further 2 to 10 mass %.

Examples of the toner particle include an additive that can be kneaded, such as a charge control agent, magnetic powder, a fluidity improver, an electric conductivity adjustor, an extender pigment, a reinforcing filler such as a fibrous substance, an antioxidant, an anti-aging agent and a cleaning property improver. The charge control agent may contain any suitable positively chargeable charge control agents and negatively chargeable charge control agents.

Examples of the positively chargeable charge control agent include: nigrosine dyes such as “Nigrosine Base EX,” “Oil Black BS,” “Oil Black SO,” “BONTRON N-01,” “BONTRON N-04,” “BONTRON N-07,” “BONTRON N-09,” and “BONTRON N-11” (which are manufactured by Orient Chemical Industries Co., Ltd.); triphenylmethane-based dyes containing a tertiary amine as a side chain; quaternary ammonium salt compounds such as “BONTRON P-51” (manufactured by Orient Chemical Industries Co., Ltd.), and cetyltrimethylammonium bromide, “COPY CHARGE PX VP435” (manufactured by Clariant Ltd.); polyamine resins such as “AFP-B” (manufactured by Orient Chemical Industries Co., Ltd.); imidazole derivatives such as “PLZ-2001” and “PLZ-8001” (hereinabove, manufactured by Shikoku Chemicals Corporation); and styrene-acrylic resins such as “FCA-701PT” (manufactured by Fujikura Kasei Co., Ltd.).

In addition, examples of the negatively chargeable charge control agent include: metal-containing azo dyes such as “VARIFAST BLACK 3804,” “BONTRON S-31,” “BONTRON S-32,” “BONTRON S-34” and “BONTRON S-36” (hereinabove, manufactured by Orient Chemical Industries Co., Ltd.), and “AIZEN SPILON BLACK TRH” and “T-77” (manufactured by Hodogaya Chemical Co., Ltd.); metal compounds of benzilic acid compound such as “LR-147” and “LR-297” (hereinabove, manufactured by Japan Carlit Co., Ltd.); metal compounds of salicylic acid compound such as “BONTRON E-81,” “BONTRON E-84,” “BONTRON E-88” and “BONTRON E-304” (hereinabove, manufactured by Orient Chemical Industries Co., Ltd.), and “TN-105” (manufactured by Hodogaya Chemical Co., Ltd.); copper phthalocyanine dyes; quaternary ammonium salts such as “COPY CHARGE NX VP434” (manufactured by Clariant Ltd.) and nitroimidazole derivatives; organometallic compounds; and the like.

In addition, a cleaning aid such as a metal soap, an inorganic or organic metal salt, can be used in combination with the charge control agent. Examples of the metal soap include aluminum tristearate, aluminum distearate, stearates of barium, calcium, lead and zinc, linoleates of cobalt, magnanese, lead and zinc, octoates of aluminum, calcium and cobalt, oleates of calcium and cobalt, zinc palmitate, naphthenates of calcium, cobalt, manganese, lead and zinc, and resinsates of calcium, cobalt, manganese, lead and zinc. In addition, the inorganic or organic metal salt may be a salt in which a cationic component of the metal salt is selected from the group consisting of metals of Ia, IIa and IIIa groups of the periodic table, and an anionic component of the salt is selected from the group consisting of halide ions, carbonate ions, acetate ions, sulfate ions, borate ions, nitrate ions and phosphate ions. Such charge control agent and cleaning aid are added in an amount within a range selected from 0.01 to 20 mass %, 0.1 to 5 mass %, or 0.5 to 2.5 mass % relative to the toner particle to produce a suitable effect.

Examples of the toner particle may contain a magnetic substance so as to enable the toner particle to be magnetized. Examples of the magnetic substance include: metals such as iron, cobalt and nickel and alloys thereof; metallic oxides such as Fe₃O₄, γ-Fe₂O₃ and cobalt-containing iron oxide; and those formed of various ferrites such as MnZn ferrite and NiZn ferrite. Among the above, the magnetic substance may be Fe₃O₄ of 0.05 to 0.5 pam, according to examples. Such magnetic substance may be used after treatment with various treatment agents such that they have hydrophobicity. In addition, a plurality of such magnetic substances may be used in combination. When the toner is used as magnetic toner, the magnetic substances may be added in an amount within a range selected from 0.2 to 2.0 mass %, 0.4 to 1.5 mass % or further 0.5 to 1.0 mass % relative to the toner particle.

Examples of the toner particle may have a sea-island structure including a matrix portion of a pendant-type non-crystalline polyester resin and a domain portion of a wax. According to examples, the domain portion may have a longitudinal diameter within a range of 0.3 μm to 2.0 μm. According to examples, at least a part of the domain portion may be a two-layer domain portion, around which a compatible layer of a crystalline polyester resin and a pendant-type non-crystalline polyester resin is coated. The domain portion having a longitudinal diameter in the above-described range provides a suitable particle size to improve anti-offset property and durability.

In addition, the ratio of the two-layer domain portion in the domain portion may be within a range of 10 mass % to 50 mass %, to achieve a suitable miscibility between the pendant-type non-crystalline polyester resin and the crystalline polyester resin, and an improved low-temperature fixing property.

According to examples, the toner particle may have a structure wherein the crystalline polyester resin is dispersed in the non-crystalline polyester resin. The average particle diameter of dispersed particles of the crystalline polyester resin in the non-crystalline polyester resin may be within a range having a minimum of 5 nm or 10 nm, and a maximum of 500 nm or 250 nm. This average particle diameter can be calculated from a TEM (transmission electron microscope) image for example. Note that this average particle diameter may be measured in a state where, before production of toner particles, the non-crystalline polyester resin and the crystalline polyester resin are mixed.

According to examples, the toner particle may be produced by any of grinding method or polymerization methods. In order to provide a predetermined sea-island structure as described above, the production may be carried out by, for example, a polymerization method.

An example method for producing, by a polymerization method, a toner particle containing as a binder resin, a non-crystalline polyester resin containing a polyfunctional carboxylic acid unit having a pendant group (which may be referred to hereinafter as “pendant-type non-crystalline polyester resin”) and a crystalline polyester resin will be described.

A polycarboxylic acid containing a polycarboxylic acid having a branched chain, a polyhydric alcohol, an esterification catalyst and other compounds are fed into a reaction vessel, and an esterification reaction is caused, to obtain a pendant-type non-crystalline polyester resin. The resulting pendant-type non-crystalline polyester resin obtained is dissolved in a suitable solvent such as methyl ethyl ketone or isopropyl alcohol and subjected to pH adjustment, addition of water, removal of the solvent and the like, so that a latex is obtained as a pendant-type non-crystalline polyester resin dispersion of a predetermined or targeted concentration.

To achieve a crystalline polyester resin, an esterification reaction and preparation of a latex as a dispersion are carried out in a similar manner as for the pendant-type non-crystalline polyester resin.

In addition, in accordance with the conditions for a polymerization method, a colorant dispersion and a wax dispersion are prepared. For example, for preparation of a wax dispersion, a wax, an anionic surfactant and water are input first into a reaction vessel. A content of a releasing agent in the mixture of wax, anionic surfactant and water is determined suitably in consideration of the dispersed state. Examples of the anionic surfactant include alkyl benzene sulfonate. A content of the anionic surfactant in the mixture of wax, anionic surfactant and water is determined suitably in consideration of the dispersed state. A content of water in the mixture of release agent, anionic surfactant and water is determined suitably in consideration of the dispersed state, the preservability and the economic efficiency. Subsequently, in the releasing agent dispersion forming process, the mixture of the releasing agent, anionic surfactant and water is subjected to dispersion treatment, to obtain a releasing agent dispersion. Examples of a method for dispersion treatment of the mixture include a method using a homogenizer. In addition, the colorant dispersion and the wax dispersion may be commercially available ones.

First, the pendant-type non-crystalline polyester resin latex and the crystalline polyester resin latex are mixed in, for example, an aqueous system, and then, mixed with the colorant dispersion and the wax dispersion (liquid mixture forming operation).

The resulting liquid mixture is added with a coagulant, stirred by a homogenizer and heated, so that a particle aggregate containing a binder resin containing a pendant-type non-crystalline polyester resin and a crystalline-polyester resin, a colorant and a wax is obtained. Next, the pendant-type non-crystalline polyester resin latex is further added for mixing, so that a coated particle aggregate having a surface of the particle aggregate provided with a coating layer formed of the pendant-type non-crystalline polyester resin (coated particle aggregate forming operation).

In addition, the coated particle aggregate is heated and thereby, particles within the coated particle aggregate are fused and coalesced, so that toner particles are obtained. This method can provide toner particles that are referred to as core-shell-type toner particles (fusing/coalescing operation).

Examples of the coagulant include iron-based metal salts. Specific examples thereof include polysilicate iron and polyaluminum chloride.

The coagulant can be added in an amount of 0.4 to 3.0 weight %, or 0.6 to 2.0 weight % relative to the entire amount of raw materials. When the amount to be added of the coagulant is 0.4 to 3.0 weight %, the toner particle diameter can be kept within a suitable range described below.

According to examples, a volume average particle diameter of the toner particle can be set to a value within a range of 3 to 9 μm, or 2.5 to 8.5 pam. A volume average particle diameter of 3 to 9 μm can easily create fine images.

In addition, in the example toner, an amount of presence of particles having a particle diameter of 3 μm or less is 3 number % or less, or 2.5 number % or less. According to examples, the amount of presence of particles having a particle diameter of 3 μm or less is 3 number % or less, to achive a toner for electrostatic image development having a uniform particle diameter.

According to examples, the toner particle contains a non-crystalline polyester resin containing a polyfunctional carboxylic acid unit having a pendant group with 3 to 32 carbons, a crystalline polyester resin, a releasing agent and a dispersant reduce the minimum fixing temperature, increase hot offset temperature and achieve a suitable storage stability.

Examples and Comparative Examples will be described.

Various measurement methods and evaluation methods for the Examples and Comparative Examples, will be described.

Temperature at which storage elastic modulus of toner particle reaches 0.1 MPa

A rotary plate-type rheometer “ARES” (manufactured by TA Instruments) was used as a measurement apparatus. A measurement sample was prepared by pressure-molding 0.25 of toner at 20 MPa for 1 minute by use of a tablet molding device. When the temperature was increased from 40° C. to 120° C. under conditions of a temperature increase rate of 2° C./min, a frequency of 10 Hz and a strain amount control mode (strain amount: 0.01% to 3%), a storage elastic modulus G′ was measured and a change curve of G′ relative to the temperature was obtained. A temperature at which the storage elastic modulus G′ reached 0.1 MPa was read.

Minimum Fixing Temperature

A belt-type fixing device (fixing device of Color Laser 660 Model (trade name) manufactured by Samsung Electronics Co., Ltd.) was used. An unfixed image for test with a 100% solid pattern was fixed on a test paper sheet of 60 g (X-9 (trade name) manufactured by Boise) under conditions of a fixing speed of 160 mm/sec and a fixing period of 0.08 sec. The fixing of the unfixed image for test was carried out at each temperature at 1° C. intervals in the range of 110° C. to 170° C. An initial optical density of the fixed image was measured. Subsequently, a 3M 810 tape was adhered to an image portion, a weight of 500 g was reciprocated 5 times; and then, the tape was removed. Subsequently, an optical density after removal of the tape was measured. A minimum fixing temperature was the lowest temperature taken among temperatures at which the fixing property (%) reached 90% or more when calculated by the following equation.

Fixing property (%)=(initial optical density/optical density after tape removal)×100

Storage Characteristic

100 g of toner particles was charged into a mixer (KM-LS2K (trade name) manufactured by Daewha TECH), and then, 0.5 g of NX-90 (manufactured by Nippon Aerosil Co., Ltd.), 1.0 g of RX-200 (manufactured by Nippon Aerosil Co., Ltd.) and 0.5 of SW-100 (manufactured by Titan Kogyo, Ltd.) were added as external additives. Subsequently, the mixture was stirred for 4 minutes at a stirring speed of 8,000 rpm to allow the external additives to be adhered to toner particles. Then, the toner having the external additives adhered thereto was charged into a developing device (Color Laser 660 Model (trade name) manufactured by Samsung Electronics Co., Ltd.); stored for 2 hours by use of a thermo-hygrostat oven in an environment with a temperature of 23° C. and a relative humidity of 55% (ordinary temperature and humidity); and further, stored for 48 hours in an environment with a temperature of 40° C. and a relative humidity of 90% (high temperature and humidity). After storage under these conditions, the toner in the developing device was visually observed as to whether or not caking occurred. Further, a 100% solid pattern was output and the output image was visually observed and evaluated on the preservability as described below.

O: excellent (or satisfactory) image, no caking
A: defective image, no caking
x: caking occurred

Hot Offset Temperature

A belt-type fixing device (Color Laser 660 Model (trade name) manufactured by Samsung Electronics Co., Ltd.) was used. An unfixed image for test with a 100% solid pattern was fixed on a test paper sheet of 60 g (X-9 (trade name) manufactured by Boise) under conditions of a fixing speed of 160 mm/sec and a fixing period of 0.08 sec. The fixing of the unfixed image for test was carried out at each temperature at 5° C. intervals in the range of 110° C. to 180° C. Hot offset was visually checked, and a lowest temperature at which hot offset occurred was taken as a hot offset temperature.

Volume average particle diameter and amount of presence of particles having a particle diameter of 3 μm or less in terms of number average particle diameter distribution

Regarding the toner particle, a volume average particle diameter and an amount of presence of particles having a particle diameter of 3 μm or less in terms of number average particle diameter distribution were measured by an aperture electric resistance method. Specifically, a Coulter Counter (manufactured by Beckman Coulter Inc.) was used as a measurement apparatus, ISOTON II (manufactured by Beckman Coulter Inc.) was used as an electrolyte solution, an aperture tube with an aperture diameter of 100 μm was used, and the measurement was carried out under the condition of a measurement particle number of 30,000. Based on the particle size distribution of measured particles, a volume occupied by particles included in a divided particle size range was accumulated from a smaller diameter, and a particle diameter satisfying an accumulated volume of 50% was taken as the volume average particle diameter (Dv50). Based on the particle size distribution of measured particles, the number % of particles with a particle diameter of 3 μm or less was taken as an amount of presence of particles having a particle diameter of 3 μm or less in terms of number average particle diameter.

Tg2nd-dH

A modulated differential scanning calorimeter Q2000 (manufactured by TA Instruments) was used. As a first temperature increasing process, the temperature was increased from room temperature to 140° C. at a rate of 3° C. per minute with a modulating amplitude of 0.1° C. and a modulating period of 10 seconds; and subsequently, the temperature was decreased to 0° C. at a rate of 20° C. per minute. After the temperature was kept at 0° C. for 5 minutes, the temperature was again increased as a second temperature increasing process from 0° C. to 140° C. at a rate of 3° C. per minute with a modulating amplitude of 0.1° C. and a modulating period of 10 seconds, and a dH was determined from a differential scanning calorimetry curve. If the crystalline polyester has a melting point close to those of the releasing agent and the dispersant, an endothermic amount of the crystalline polyester was defined by a portion obtained by subtracting the entire endothermic amount from endothermic amounts of the releasing agent and the dispersant. For example, the separately-measured endothermic amounts of the releasing agent and the dispersant were multiplied by respective mass % in the toner particle, and were subtracted from the entire endothermic amount.

Examples for binder resins and toner particles will be described.

Resin 1 to Resin 3, and Resin 5 Feeding amounts shown in Tables 1A and 1B of polyfunctional carboxylic acids and polyols, and 1 mass % of dibutyltin oxide as an esterification catalyst relative to the raw materials were charged into a 5-liter four-necked flask equipped with a nitrogen introduction tube, a dehydration tube, a stirrer and a thermocouple; and a reaction was caused under a nitrogen atmosphere at 230° C. until a reaction rate reached 90%. Then, a reaction was caused at 8.3 kPa until a weight average molecular weight reached a targeted level, so that Non-crystalline Polyester Resin 1 of Tables 1A and 1B was obtained.

Non-crystalline Polyester Resins 2, 3 and 5 of Tables 1A and 1B were produced similarly to Non-crystalline Polyester Resin 1, with the exception that kinds and feeding amounts of the polyfunctional carboxylic acids and polyols were varied as shown in Tables 1A and 1B.

Resin 4

Feeding amounts shown in Tables 1A and 1B of the polyfunctional carboxylic acids and polyols, and 1 mass % of dibutyltin oxide as an esterification catalyst relative to the raw materials were charged into a 5-liter four-necked flask equipped with a nitrogen introduction tube, a dehydration tube, a stirrer and a thermocouple; and a reaction was caused under a nitrogen atmosphere at 230° C. until a reaction rate reached 90%. Then, the reaction temperature was decreased to 210° C., trimellitic anhydride was added, and a reaction was caused for 1 hour at atmospheric pressure. Then, a reaction was caused at 8.3 kPa until a weight average molecular weight reached a targeted level, so that Non-crystalline Polyester Resin 4 of Tables 1A and 1B was obtained.

Resins 6 and 7

Feeding amounts shown in Tables 1C and 1D of polyfunctional carboxylic acids and polyols, and 1 mass % of dibutyltin oxide as an esterification catalyst relative to the raw materials were charged into a 5-liter four-necked flask equipped with a nitrogen introduction tube, a dehydration tube, a stirrer and a thermocouple; and a reaction was caused under a nitrogen atmosphere at 180° C. until a reaction rate reached 90%. Then, a reaction was caused at 8.3 kPa until a weight average molecular weight reached a targeted level, so that Crystalline Polyester Resins 6 and 7 of Tables 1C and 1D were obtained.

Tables 1A, 1B, 1C and 1D show the production examples of binder resins 1 to 7.

TABLE 1A

| | | | Carbons of | Non-crystalline polyester | | | | |
|---|---|---|---|---|---|---|---|---|
| | | | pendant | Resin | | | | |
| | | | group | 1 | 2 | 3 | 4 | 5 |
| Amount of | Polyfunctional | Dodecyl succinate | 12 | 12 | | 6 | | |
| polyfunctional | carboxylic acid | anhydride | | | | | | |
| carboxylic acid | having pendant | Octadecyl succinate | 18 | | 2 | | | |
| added (mol %) | group | anhydride | | | | | | |
| | Polyfunctional | Terephthalic acid | — | 36 | 15 | 42 | 47 | 49 |
| | carboxylic acid | Trimellitic anhydride | — | | | | 3 | |
| | having no | Succinic acid | — | | | | | |
| | pendant group | Dodecanoic diacid | — | | | | | |

TABLE 1B

| | | Non-crystalline polyester | | | | |
|---|---|---|---|---|---|---|
| | | Resin | | | | |
| | | 1 | 2 | 3 | 4 | 5 |
| Amount of | BPA-2PO¹⁾ | 52 | 13 | 52 | 36 | 51 |
| polyol added | BPA-2EO²⁾ | | | | 14 | |
| (mol %) | 1,6-hexane diol | | | | | |
| | 1,9-nonane diol | | | | | |
| | Polyethylene | | 70 | | | |
| | terephthalate | | | | | |

| | | | | | |
|---|---|---|---|---|---|
| Content ratio of polyfunctional | 12 | 2 | 6 | 0 | 0 |
| carboxylic acid having pendant | | | | | |
| group (mol %) | | | | | |
| Weight average molecular weight | 10575 | 9076 | 10658 | 56473 | 10685 |
| (Dalton) | | | | | |

¹⁾bisphenol A-propylene oxide dimeric adduct
²⁾bisphenol A-ethylene oxide dimeric adduct

TABLE 1C

| | | | | Crystalline | |
|---|---|---|---|---|---|
| | | | Carbons of | polyester | |
| | | | pendant | Resin | |
| | | | group | 6 | 7 |
| Amount of | Polyfunctional | Dodecyl | 12 | | |
| polyfunctional | carboxylic acid | succinate | | | |
| carboxylic acid | having pendant | anhydride | | | |
| added (mol %) | group | Octadecyl | 18 | | |
| | | succinate | | | |
| | | anhydride | | | |
| | Polyfunctional | Terephthalic | — | | |
| | carboxylic acid | acid | | | |
| | having no | Trimellitic | — | | |
| | pendant group | anhydride | | | |
| | | Succinic acid | — | 49 | |
| | | Dodecanoic | — | | 49 |
| | | diacid | | | |

TABLE 1D

| | | Crystalline polyester | |
|---|---|---|---|
| | | Resin | |
| | | 6 | 7 |
| Amount of | BPA-2PO¹⁾ | | |
| polyol added | BPA-2EO²⁾ | | |
| (mol %) | 1,6-hexane diol | 51 | |
| | 1,9-nonane diol | | 51 |
| | Polyethylene | | |
| | terephthalate | | |

| | | |
|---|---|---|
| Content ratio of polyfunctional carboxylic | 0 | 0 |
| acid having pendant group (mol %) | | |
| Weight average molecular weight (Dalton) | 6500 | 7000 |

¹⁾bisphenol A-propylene oxide dimeric adduct
²⁾bisphenol A-ethylene oxide dimeric adduct

### Example 1 of Production of Latex

300 g of Non-crystalline Polyester Resin 1, 250 g of methyl ethyl ketone, and 50 g of isopropyl alcohol were charged into a 3-liter double-jacket reaction vessel, and stirred under an environment of about 30° C. by use of a semi-moon type impeller in the reaction vessel, so that the resin was dissolved. While the obtained resin solution was stirred, 20 g of 5% ammonium aqueous solution was gradually added into the reaction vessel, and subsequently 1200 g of water was added at a rate of 20 g/min, so that an emulsified liquid was produced. Subsequently, the solvent mixture of methyl ethyl ketone and isopropyl alcohol was removed from the emulsified liquid by a reduced-pressure distillation method until the concentration of Non-crystalline Polyester Resin 1 as a solid content reached 20 mass %, so that a resin latex was obtained.

Latexes containing Non-crystalline Polyester Resins 2 to 5 were obtained in a similar manner, with the exception that Non-crystalline Polyester Resin was changed.

### Example 2 of Production of Latex

300 g of Crystalline Polyester Resin 6, 250 g of methyl ethyl ketone, and 50 g of isopropyl alcohol were charged into a 3-liter double-jacket reaction vessel, and stirred under an environment of about 30° C. by use of a semi-moon type impeller in the reaction vessel, so that the resin was dissolved. While the obtained resin solution was stirred, 25 g of 5% ammonium aqueous solution was gradually added into the reaction vessel, and subsequently 1200 g of water was added at a rate of 20 g/min, so that an emulsified liquid was produced. Subsequently, the solvent mixture of methyl ethyl ketone and isopropyl alcohol was removed from the emulsified liquid by a reduced-pressure distillation method until the concentration of Crystalline Polyester Resin 1 as a solid content reached 20 mass %, so that a resin latex was obtained.

A latex containing Crystalline Polyester Resin 7 was obtained in a similar manner, with the exception that Crystalline Polyester Resin was varied.

### Preparation Example of Colorant Dispersion Liquid

10 g of an anionic reactive emulsifier (HS-10 manufactured by DKS Co., Ltd.) was charged into a milling bath together with a Cyan pigment (C.I. Pigment blue 15:3 manufactured by Clariant AG). Further, 400 g of glass beads with a diameter of 0.8 mm or more and 1 mm or less was charged. Then, milling at normal temperature provided a colorant dispersion liquid.

<Dispersants 1 to 5>

Feeding amounts shown in Table 2 of alcohols and carboxylic acids, and 1 mass % of dibutyltin oxide as an esterification catalyst relative to the raw materials were charged into a 5-liter four-necked flask equipped with a nitrogen introduction tube, a dehydration tube, a stirrer and a thermocouple; and a reaction was caused under a nitrogen atmosphere at 180° C. until a reaction rate reached 90%. Then, a reaction was caused at 8.3 kPa until an acid value reached 3 or less, so that Dispersants 1 to 5 of Table 2 were obtained.

Table 2 shows production examples of the Dispersants 1 to 5.

TABLE 2

| | | Carbons | | | | | |
|---|---|---|---|---|---|---|---|
| | | (except | Mixing ratio of alcohol and carboxylic acid | | | | |
| | | carbonyl | Dispersant | | | | |
| | | carbons) | 1 | 2 | 3 | 4 | 5 |
| Alcohol | Stearyl alcohol | 18 | 1 | 1 | | 2 | |
| | Behenyl alcohol | 22 | | | 1 | | |
| | Sorbitan | 6 | | | | | 1 |
| Carboxylic | Stearic acid | 17 | 1 | | | | 4 |
| acid | Behenic acid | 22 | | 1 | 1 | | |
| | Eicosane diacid | 20 | | | | 1 | |

| | | | | | |
|---|---|---|---|---|---|
| Melting point (° C.) | 64.8 | 69.9 | 77.4 | 87.1 | 55.0 |
| Endothermic amount (J/g) | 206 | 202 | 215 | 211 | 197 |

### Preparation Example of Dispersion Liquid of Dispersant

270 g of the synthesized dispersant 1, 2.7 g of an anionic surfactant (Dowfax 2A1 (trade name) manufactured by Dow Chemical Co.), and 400 g of ion exchanged water were charged into a reaction vessel. Subsequently, the mixture was heated to 110° C. in the reaction vessel, dispersed by use of a homogenizer (Ultra-Turrax T50 (trade name) manufactured by IKA), and further dispersed by use of a high-pressure homogenizer (NanoVater NVL-ES008 (trade name) manufactured by Yoshida Kikai Co., Ltd.), so that Dispersant 1 Dispersion Liquid containing Dispersant 1 was obtained.

Dispersion liquids of dispersants containing Dispersants 2 to 5 were obtained in a similar manner as for Dispersant 1, with the exception that the type of dispersant was changed. In addition, the endothermic amount of a single dispersant was measured by the same method as the method for measuring an endothermic among of the above-described toner particle, and is shown in Table 2.

### Example 1 of Preparation of Dispersion Liquid of Releasing Agent

270 g of paraffin wax (HNP-5 (trade name) manufactured by Nippon Seiro Co., Ltd.), 2.7 g of an anionic surfactant (Dowfax 2A1 (trade name) manufactured by Dow Chemical Co.), and 400 g of ion exchanged water were charged into a reaction vessel. Subsequently, the mixture was heated to 110° C. in the reaction vessel, dispersed by use of a homogenizer (Ultra-Turrax T50 (trade name) manufactured by IKA), and further dispersed by use of a high-pressure homogenizer (NanoVater NVL-ES008 (trade name) manufactured by Yoshida Kikai Co., Ltd.), so that a Releasing Agent Dispersion Liquid containing Releasing Agent 1 was obtained.

Releasing Agent Dispersion Liquids containing Releasing Agents 2 to 5 were obtained in a similar manner, with the exception that the kind of releasing agent was changed. In addition, the endothermic amount of a releasing agent alone was measured by the same method as the method for measuring an endothermic among of the above-described toner, and is shown in Table 3.

Table 3 shows a list of releasing agents 1 to 5.

TABLE 3

| Releasing | | Product | Melting point | Endothermic |
|---|---|---|---|---|
| agent | Maker | No. | (° C.) | amount (J/g) |
| 1 | Nippon | HNP-5 | 63 | 198 |
| | Seiro | | | |
| 2 | Nippon | HNP-11 | 68 | 201 |
| | Seiro | | | |
| 3 | Nippon | HNP-9 | 75 | 205 |
| | Seiro | | | |
| 4 | Sasol | C80N8 | 88 | 208 |
| 5 | Sasol | H1 | 112 | 210 |

### Preparation of Toner Particle of Example 1

815 g of deionized water, 419 g of latex containing Non-crystalline Polyester Resin 1 (solid content concentration: 20%), 179 g of latex containing Non-crystalline Polyester Resin 4 (solid content concentration: 20%), and 149 g of latex containing Crystalline Polyester Resin 7 (solid content concentration: 20%) were charged into a 3-liter reaction vessel. Subsequently, 54 g of colorant dispersion liquid (solid content concentration: 20%), 8.1 g of Releasing Agent 2 Dispersion Liquid (solid content concentration: 40%), and 45.9 g of Dispersant 3 Dispersion Liquid (solid content concentration: 40%) were added; and 61.7 g of polysilicate iron (PSI-100 manufactured by Suido Kiko Kaisha, Ltd.) as a coagulant was added. While being stirred by use of a homogenizer (Ultra-Turrax T50 (trade name) manufactured by IKA), the mixture solution in the flask was heated to 45° C. at a rate of 1° C./min.

Subsequently, the aggregation reaction solution was heated at a rate of 0.2° C./min to continue aggregation reaction, and thereby, a primary particle aggregate having a volume average particle diameter of 4 μm or more and 6 μm or less was obtained. For a shell layer, 203.5 g of Latex 1 containing Non-crystalline Polyester Resin 1 and 87.2 g of Latex containing Non-crystalline Polyester Resin 4 were added to the reaction vessel to cause aggregation for 30 minutes. Next, 0.1 N of NaOH aqueous solution was added to adjust the pH of the mixture solution to 9.5. After a lapse of 20 minutes, the mixture solution was heated to cause fusing for 3 hours or longer and 5 hours or shorter, thereby providing a secondary particle aggregate having a volume average particle diameter of 4 μm or more and 7 μm or less.

Ice of deionized water was added to this aggregation reaction solution at a rate of 100 ml/10 sec. to cool the solution to 28° C. or lower. Then, after a filtration process, particles were separated and dried, so that toner particles of Example 1 were obtained.

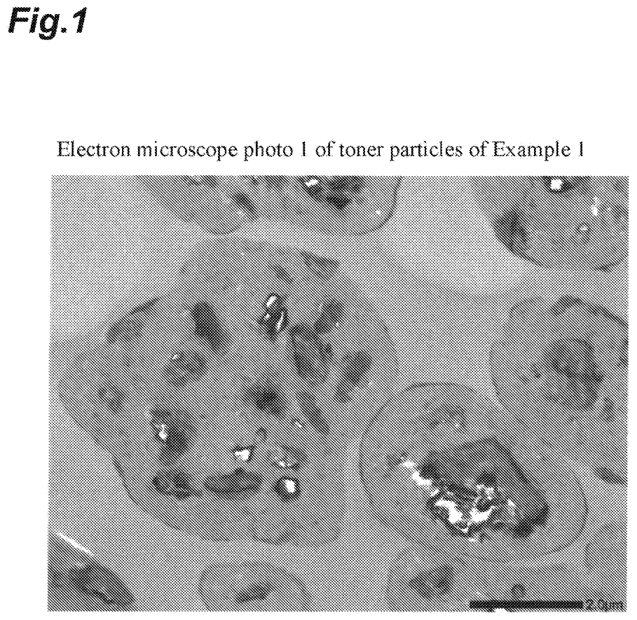

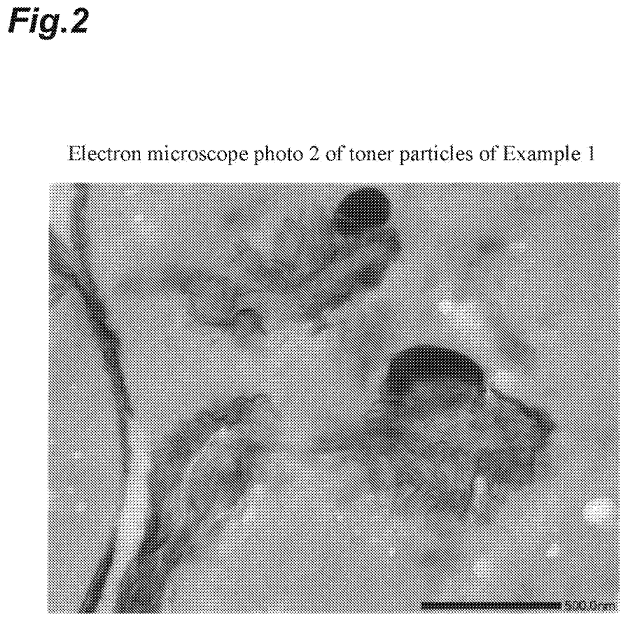

Electron microscope photographs of the toner particles obtained in Example 1 are shown in FIGS. 1 and 2. A portion where crystalline resins are dispersed in non-crystalline resins (cf. FIG. 1), and a portion where crystalline resins are grown from around dispersants in a lamella-like manner (cf. FIG. 2) are observed.

### Example 2

Toner particles of Example 2 were obtained a similar method as in Example 1 with the exception that Releasing Agent 2 Latex was changed to Releasing Agent 1 Latex (solid content concentration: 20%) and Dispersant 2 Dispersion Liquid was changed to Dispersant 1 Dispersion Liquid (solid content concentration: 40%).

### Example 3

Toner particles of Example 3 were obtained by a similar method as in Example 1 with the exception that: 149 g of Crystalline Polyester Resin 7 Latex was changed to 48.9 g of Crystalline Polyester Resin 6 Latex (solid content concentration: 20%) and 98.9 g of Crystalline Polyester Resin 7 Latex; Releasing Agent 2 Dispersion Liquid was changed to Releasing Agent 4 Dispersion Liquid; and Dispersant 3 Dispersion Liquid was changed to Dispersant 4 Dispersion (solid content concentration: 40%).

### Example 4

Toner particles of Example 4 were obtained by a similar method as in Example 1 with the exception that: 8.1 g of Releasing Agent 2 Dispersion Liquid was changed to 13.3 g of Releasing Agent 3 Dispersion Liquid; and 45.9 g of Dispersant 3 Dispersion Liquid was changed to 40.5 g of Dispersant 3 Dispersion Liquid.

### Example 5

Toner particles of Example 5 were obtained by a similar method as in Example 1 with the exception that: 8.1 g of Releasing Agent 2 Dispersion Liquid was changed to 20.8 g of Releasing Agent 4 Dispersion Liquid (solid content concentration: 40%); and 45.9 g of Dispersant 3 Dispersion Liquid was changed to 32.2 g of Dispersant 4 Dispersion Liquid.

### Examples 6 to 9

Toner particles of Examples 6 to 9 were obtained by a similar method manner as in Example 1 with the exception that the kinds and amounts of the non-crystalline polyester resin latex, the crystalline polyester resin latex, the releasing agent dispersion liquid, and dispersant dispersion liquid were varied from those of Example 1 in accordance with the composition ratios indicated in Table 4A.

### Comparative Examples 1 to 7

Toner particles of Comparative Examples 1 to 7 were obtained by a similar method as in Example 1 with the exception that the kinds and amounts of the non-crystalline polyester resin latex, the crystalline polyester resin latex, the releasing agent dispersion liquid, and dispersant dispersion liquid were varied from those of Example 1 in accordance with the composition ratios of Table 4C.

Tables 4A, 4B3, 4C and 4D show the production of toner particles according to Examples 1 to 9 and Comparative Examples 1 to 7.

TABLE 4A

| | | | Examples | | | | | | | | |
|---|---|---|---|---|---|---|---|---|---|---|---|
| | | | 1 | 2 | 3 | 4 | 5 | 6 | 7 | 8 | 9 |
| Core | Non-crystalline | 1 | 34.9 | 34.9 | 34.9 | 34.9 | 34.9 | 34.9 | | 37.1 | 26.2 |
| | polyester resin | 2 | | | | | | | 34.9 | | |
| | | 3 | | | | | | | | | |
| | | 4 | 15.0 | 15.0 | 15.0 | 15.0 | 15.0 | 15.0 | 15.0 | 15.0 | 11.2 |
| | | 5 | | | | | | | | | |
| | Crystalline | 6 | | | 4.1 | | | | | | |
| | polyester resin | 7 | 12.5 | 12.5 | 8.3 | 12.5 | 12.5 | 12.5 | 12.5 | 9.3 | 24.9 |
| | Releasing | 1 | | 1.4 | | | | 3.6 | | | |
| | agent | 2 | 1.4 | | | | | | 1.4 | 1.4 | 1.4 |
| | | 3 | | | | 2.3 | | | | | |
| | | 4 | | | 1.4 | | 3.6 | | | | |
| | | 5 | | | | | | | | | |
| | Dispersant | 1 | | 7.7 | | | | 5.4 | | | |
| | | 2 | | | | | | | | | |
| | | 3 | 7.7 | | | 6.8 | | | 7.7 | 7.7 | 7.7 |
| | | 4 | | | 7.7 | | 5.4 | | | | |
| | | 5 | | | | | | | | | |
| | Colorant | | 4.5 | 4.5 | 4.5 | 4.5 | 4.5 | 4.5 | 4.5 | 4.5 | 4.5 |
| Shell | Non-crystalline | 1 | 17.0 | 17.0 | 17.0 | 17.0 | 17.0 | 17.0 | 17.0 | 17.0 | 17.0 |
| | polyester resin | 4 | 7.3 | 7.3 | 7.3 | 7.3 | 7.3 | 7.3 | 7.3 | 7.3 | 7.3 |
| | | 5 | | | | | | | | | |

TABLE 4B

| | Examples | | | | | | | | |
|---|---|---|---|---|---|---|---|---|---|
| | 1 | 2 | 3 | 4 | 5 | 6 | 7 | 8 | 9 |
| Mass ratio of dispersant/ | 85:15 | 85:15 | 85:15 | 75:25 | 60:40 | 60:40 | 85:15 | 85:15 | 85:15 |
| releasing agent | | | | | | | | | |
| Melting point of | 68.0 | 63.0 | 88.0 | 75.0 | 88.0 | 63.0 | 68.0 | 68.0 | 68.0 |
| releasing agent (° C.) | | | | | | | | | |
| Melting point of | 77.4 | 64.8 | 87.1 | 77.4 | 87.1 | 64.8 | 77.4 | 77.4 | 77.4 |
| dispersant (° C.) | | | | | | | | | |
| Dv50 (μm) | 5.8 | 5.9 | 5.8 | 5.8 | 5.7 | 6.0 | 5.8 | 5.8 | 5.9 |
| Amount of presence of | 2.8 | 3.1 | 3.1 | 3.5 | 3.0 | 2.9 | 2.8 | 2.8 | 2.7 |
| particles having a | | | | | | | | | |
| particle diameter of | | | | | | | | | |
| 3 μm or less (number %) | | | | | | | | | |

TABLE 4C

| | | | Comparative Examples | | | | | | |
|---|---|---|---|---|---|---|---|---|---|
| | | | 1 | 2 | 3 | 4 | 5 | 6 | 7 |
| Core | Non-crystalline | 1 | 34.9 | 34.9 | 34.9 | 34.9 | | 26.2 | 38.3 |
| | polyester resin | 2 | | | | | | | |
| | | 3 | | | | | | | |
| | | 4 | 15.0 | 15.0 | 15.0 | 15.0 | 15.0 | 11.2 | 16.4 |
| | | 5 | | | | | 34.9 | | |
| | Crystalline | 6 | | | | | | | |
| | polyester resin | 7 | 12.5 | 12.5 | 12.5 | 12.5 | 12.5 | 24.9 | |
| | Releasing agent | 1 | | | | | | | |
| | | 2 | | 9.0 | | | 1.4 | 7.7 | |
| | | 3 | | | | | | | |
| | | 4 | | | 5.4 | | | | |
| | | 5 | | | | 2.3 | | | |
| | Dispersant | 1 | | | | | | | |
| | | 2 | | | | | | | |
| | | 3 | 9.0 | | | | 7.7 | 1.4 | |
| | | 4 | | | 3.6 | | | | |
| | | 5 | | | | 6.8 | | | |
| | Colorant | | 4.5 | 4.5 | 4.5 | 4.5 | 4.5 | 4.5 | 4.9 |
| Shell | Non-crystalline | 1 | 17.0 | 17.0 | 17.0 | 17.0 | | 17.0 | 18.6 |
| | polyester resin | 4 | 7.3 | 7.3 | 7.3 | 7.3 | 7.3 | 7.3 | 8.0 |
| | | 5 | | | | | 17.0 | | |

TABLE 4D

| | Comparative Examples | | | | | | |
|---|---|---|---|---|---|---|---|
| | 1 | 2 | 3 | 4 | 5 | 6 | 7 |
| Mass ratio of dispersant/ | 100:0 | 0:100 | 40:60 | 75:25 | 85:15 | 15:85 | — |
| releasing agent | | | | | | | |
| Melting point of | — | 68.0 | 68.0 | 112.0 | 68.0 | 68.0 | — |
| releasing agent (° C.) | | | | | | | |
| Melting point of | 77.4 | — | 87.1 | 55.0 | 77.4 | 77.4 | — |
| dispersant (° C.) | | | | | | | |
| Dv50 (μm) | 6.0 | 5.9 | 5.7 | 5.8 | 5.8 | 5.8 | 6.0 |
| Amount of presence of | 3.2 | 2.9 | 3.5 | 3.2 | 2.9 | 2.9 | 3.0 |
| particles having a | | | | | | | |
| particle diameter of | | | | | | | |
| 3 μm or less (number %) | | | | | | | |

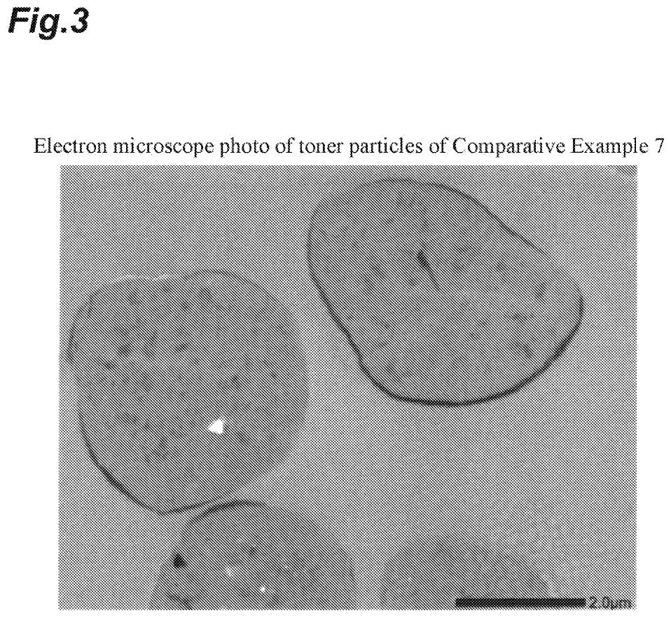

An electron microscope photograph of the toner particles obtained in Comparative Example 7 is shown in FIG. 3. A state where crystalline resins were not dispersed in non-crystalline resins and were adhered to the periphery of particles was observed.

The endothermic amount, the temperature at which the storage elastic modulus reached 0.1 MPa, the minimum fixing temperature, the hot offset temperature and the storage characteristic measured for each of the above-described toner particles are shown in Tables 5A and 5B.

Tables 5A and 5B show measurements for toner particles according to Examples f to 9 and Comparative Examples 1 to 7.

TABLE 5A

| | | Examples | | | | | | | | |
|---|---|---|---|---|---|---|---|---|---|---|
| | | 1 | 2 | 3 | 4 | 5 | 6 | 7 | 8 | 9 |
| 2nd Tg-dH of toner | | 10.2 | 9.6 | 7.1 | 9.7 | 8.1 | 9.5 | 6.8 | 10.1 | 26.9 |
| particles (J/g) | | | | | | | | | | |
| Temp. at which storage | | 87 | 85 | 90 | 88 | 90 | 89 | 86 | 93 | 84 |
| elasticmodulus of toner | | | | | | | | | | |
| particles reached | | | | | | | | | | |
| 0.1 MPa (° C.) | | | | | | | | | | |
| Fixing | Minimum | 125 | 124 | 131 | 126 | 135 | 131 | 124 | 135 | 118 |
| characteristic | fixing temp. | | | | | | | | | |
| | (° C.) | | | | | | | | | |
| | Hot offset | 180 | 175 | 180 | 180 | 175 | 175 | 180 | 180 | 175 |
| | temp. (° C.) | | | | | | | | | |

| | | | | | | | | | |
|---|---|---|---|---|---|---|---|---|---|
| Storage characteristic | ∘ | ∘ | ∘ | ∘ | ∘ | ∘ | ∘ | ∘ | ∘ |

TABLE 5B

| | | Comparative Examples | | | | | | |
|---|---|---|---|---|---|---|---|---|
| | | 1 | 2 | 3 | 4 | 5 | 6 | 7 |
| 2nd Tg-dH of toner particles (J/g) | | 9.4 | 8.4 | 7.2 | 8.6 | 3.4 | 21.7 | 6.2 |
| Temp. at which storage elastic | | 89 | 90 | 90 | 93 | 105 | 86 | 91 |
| modulus of toner particles | | | | | | | | |
| reached 0.1 MPa (° C.) | | | | | | | | |
| Fixing | Minimum | 131 | 141 | 141 | 160 | 150 | 135 | 140 |
| characteristic | fixing temp. | | | | | | | |
| | (° C.) | | | | | | | |
| | Hot offset | 155 | 165 | 170 | 180 | 180 | 150 | 140 |
| | temp. (° C.) | | | | | | | |

| | | | | | | | |
|---|---|---|---|---|---|---|---|
| Storage characteristic | ∘ | x | x | ∘ | ∘ | x | ∘ |

As shown in Examples 1 to 9, use of toner particles produced by the above-described example method achieved a minimum fixing temperature of 135° C. or lower, a hot offset temperature of 175° C. or higher, and an improved storage characteristic.

Comparative Example 1 in which a paraffin was not added as a releasing agent had a low hot offset temperature of 155° C. Comparative Example 2 not being added with a dispersant and Example 3 having a small content of the dispersant exhibited, in addition to a low hot offset temperature, a high minimum fixing temperature and a poor storage characteristic. Comparative Example 4 where the releasing agent and the dispersant had unsuitable melting points or Comparative Example 5 where the binder resin had no pendant group and the Tg2nd-dH was low exhibited a good storage characteristic while their minimum fixing temperatures or hot offset temperatures did not show satisfactory values. Comparative Example 6 having a lower content of the dispersant and Comparative Example 7 not being added with the dispersant and the releasing agent did not provide toner particles with suitable characteristics.

It is to be understood that not all aspects, advantages and features described herein may necessarily be achieved by, or included in, any one particular example. Indeed, having described and illustrated various examples herein, it should be apparent that other examples may be modified in arrangement and detail is omitted.

1. A toner particle comprising a binder resin, a colorant, a releasing agent, and a dispersant, wherein
the binder resin includes a non-crystalline polyester resin containing 1 to 15 mol % of a polyfunctional carboxylic acid unit having a pendant group with 3 to 32 carbons and a crystalline polyester resin;
an endothermic amount Tg2nd-dH derived from the crystalline polyester resin is 4 to 40 J/g;
the releasing agent has a melting point of 60 to 100° C.;
the dispersant has a melting point of 60 to 100° C.; and
a mass ratio of the dispersant to the releasing agent is 50:50 to 95:5.

2. The toner particle according to claim 1, wherein the releasing agent is a petroleum wax.

3. The toner particle according to claim 1, wherein the releasing agent is a paraffin wax.

4. The toner particle according to claim 1, wherein a content ratio of the releasing agent is 0.5 to 10 mass %.

5. The toner particle according to claim 1, wherein the dispersant is a carbonyl compound.

6. The toner particle according to claim 1, wherein the dispersant is a linear fatty acid ester.

7. The toner particle according to claim 1, wherein a content ratio of the dispersant is 2 to 15 mass %.

8. The toner particle according to claim 1, wherein the non-crystalline polyester resin has a weight average molecular weight of 4,000 to 80,000.

9. The toner particle according to claim 1, wherein the crystalline polyester resin has a weight average molecular weight of 4,000 to 30,000.

10. The toner particle according to claim 1, wherein a content ratio of the non-crystalline polyester resin in the binder resin is 40 to 90 mass %.

11. The toner particle according to claim 1, wherein a content ratio of the crystalline polyester resin in the binder resin is 5 to 30 mass %.

12. The toner particle according to claim 1, wherein a temperature at which a storage elastic modulus reaches 0.1 MPa is 100° C. or less.

13. The toner particle according to claim 1, wherein an outer surface is provided with a coating layer, and the coating layer comprises at least the non-crystalline polyester resin.

14. The toner particle according to claim 1, wherein the toner particle has a volume average particle diameter of 3 to 9 μm, and an amount of presence of particles having a particle diameter of 3 μm or less is 3 number % or less in terms of number average particle diameter distribution.

15. A method of producing a toner particle comprising:
forming a latex of a crystalline polyester resin;
forming a latex of a non-crystalline polyester resin;
mixing at least the non-crystalline polyester resin latex and the crystalline polyester resin latex to form a liquid mixture;
adding a coagulant to the liquid mixture to aggregate the non-crystalline polyester resin and the crystalline polyester resin, to obtain a primary particle aggregate;
coating a surface of the primary particle aggregate with a coating layer formed of the non-crystalline polyester resin, to obtain a coated particle aggregate; and
fusing and coalescing the coated particle aggregate at a temperature greater than a glass transition temperature of the non-crystalline polyester resin,
wherein the toner particle comprises
1 to 15 mol % of a polyfunctional carboxylic acid unit having a pendant group with 3 to 32 carbons in the non-crystalline resin,
an endothermic amount Tg2nd-dH of 4 to 40 J/g derived from the crystalline polyester resin,
a releasing agent having a melting point of 60 to 100° C.,
a dispersant having a melting point of 60 to 100° C., and
a mass ratio of the dispersant to the releasing agent of 50:50 to 95:5.
